(19) United States
(12) Patent Application Publication
(10) Pub. No.: US 2017/0064028 A1
(43) Pub. Date: Mar. 2, 2017

(54) Quality of Service Enabled Content Routing Method and Apparatus for Information Centric Networking

(71) Applicant: Futurewei Technologies, Inc., Plano, TX (US)

(72) Inventors: Cedric Westphal, San Francisco, CA (US); Guoqiang Wang, Santa Clara, CA (US)

(21) Appl. No.: 14/836,714

(22) Filed: Aug. 26, 2015

(51) Int. Cl. H04L 29/08; H04L 12/863

(52) U.S. Cl. CPC H04L 67/2842; H04L 47/6295

(57) ABSTRACT

A network element, comprising a memory that comprises a pending interest table, a receiver operably coupled to the memory and configured to receive an extended interest message in an information centric network, a processor operably coupled to the receiver and memory and configured to determine a desired content according to the extended interest message, determine a prescribed quality of service (QoS) level requested for delivering the desired content to a client, record a path state in the memory, record a return route in the pending interest table of the memory, and determine a next location in the information centric network to which the extended interest message is to be sent, and a transmitter operably coupled to the processor and configured to transmit the extended interest message to the next location in the information centric network.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

With an expansion in Internet-based services, applications, and offerings, information centric networking has grown in desirability due to the independence of data from particular locations, applications, storages, and means of transportation. For streaming services and applications, such as video streaming, video conferencing, and like-services, it may be desirable to retain the characteristics of information centric networks while facilitating an ability to prescribe a minimum quality of service (QoS) for the services and applications.

### SUMMARY

In one embodiment, the disclosure includes a network element, comprising a memory that comprises a pending interest table, a receiver operably coupled to the memory and configured to receive an extended interest message in an information centric network, a processor operably coupled to the receiver and memory and configured to determine a desired content according to the extended interest message, determine a prescribed QoS level requested for delivering the desired content to a client, record a path state in the memory, record a return route in the pending interest table of the memory, wherein the return route comprises a route through the information centric network to a return address of a previous location in the information centric network, and determine a next location in the information centric network to which the extended interest message is to be sent, and a transmitter operably coupled to the processor and configured to transmit the extended interest message to the next location in the information centric network.

In another embodiment, the disclosure includes a method implemented in a network element for routing an extended interest message in an information centric network, comprising receiving the extended interest message from a downstream node in the information centric network, determining, according to the extended interest message, data content to be retrieved, recording a return path from the network element to the downstream node in the information centric network in a pending interest table, recording a path state in the network element, and transmitting the extended interest message to an upstream node in the information centric network.

In yet another embodiment, the disclosure includes a method implemented in a network element for routing data content in an information centric network, comprising receiving the data content from an upstream node in the information centric network, determining a downstream location in the information centric network for sending the data content according to an entry in a pending interest table of the network element, associating the data content with a minimum QoS level according to a path state of the network element, and transmitting the data content to the downstream location in the information centric network with the minimum quality of service level.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a content centric network.

FIG. 2 is a schematic diagram of an embodiment of a network utilizing a resource reservation protocol.

FIG. 3 is a schematic diagram of an embodiment of an information centric network that provides a prescribed quality of service.

FIG. 4 is a schematic diagram of another embodiment of the information centric network.

FIG. 5 is a flowchart of a method for routing an extended interest message in an information centric network.

FIG. 6 is a flowchart of a method for routing data content in an information centric network.

FIG. 7 is a schematic diagram of an embodiment of a network element for index searching.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a manner for processing extended interest messages in content-based networks (e.g., information centric networks) while prescribing a minimum QoS level (e.g., a minimum amount of bandwidth in a network and/or between network elements) that should be dedicated to the transfer of data content described in the extended interest messages. In an embodiment, the extended interest messages contain a name of data content that is desired by a client, an address of a previous network node for return through the network to the client, a QoS value, indicators to correspond the data content to the QoS value, as well as other optional values for use in acquiring content for a client with a minimum QoS in a content-based network. The extended interest messages create content-based resource reservations in the network such that available network resources may be tracked and virtual tunnels with a prescribed level of QoS may be established between clients and content in the network.

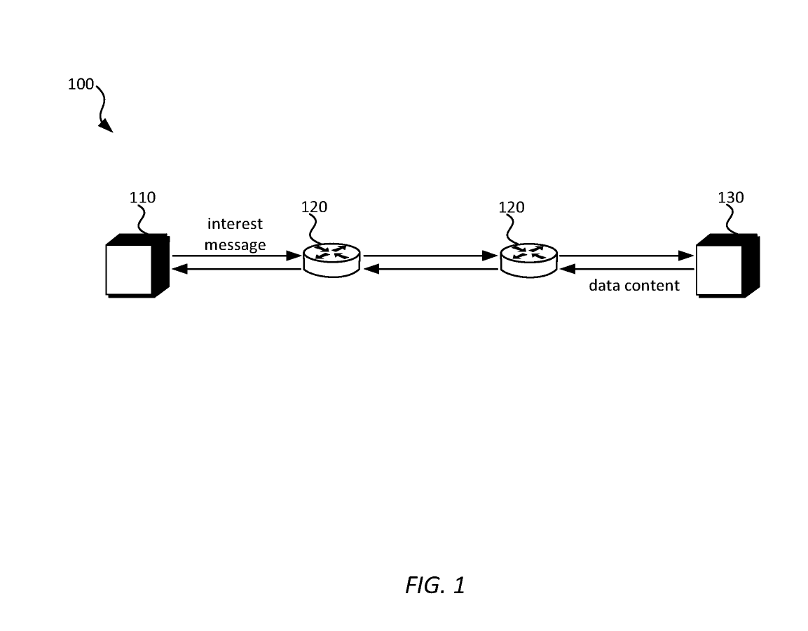

FIG. 1 is a schematic diagram of an embodiment of a content centric network (CCN) 100, which may also be referred to as a named-data network (NDN). CCN 100 includes a client 110, one or more network elements 120, and a server 130. The client 110 may be a computer, laptop, tablet, mobile phone, or other computing device operated by a user or consumer. The network elements 120 may be a switch, router, or other networking component capable of storing data and configured to route traffic through a network. The server 130 may be a computing device capable of storing data and configured to handle client requests. CCN 100 provides the client 110 with access to data, referred to as a content object, according to a name of the content object that is desired by the client. A desired content object may be stored in the server 130, or cached in the network element 120 in CCN 100. For example, the client 110 transmits an interest message to a network element 120 in CCN 100. The interest message indicates the name of the content object that client 110 wishes to receive. The network element 120 receives the interest message and determines whether the desired content object indicated by the interest message is stored in a cache on the network element 120. When the content object is not stored in a cache on the network element 120, the network element 120 records an entry in a pending interest table that indicates a path over which the desired content object should be transmitted once it is received by the network element 120. In some embodiments, the information stored in the pending interest table comprises a name of the desired content object, an indication of a location from which the interest message was received, and an indication of a location to which the interest message will be sent.

After recording the entry in the pending interest table, the network element 120 transmits the interest message to a second network element 120 in the CCN 100. The interest message is transmitted through the CCN 100 until the desired content object is found in a cache in a network element 120, or obtained from a content publisher, for example at server 130. After the desired content object is found in the CCN 100, it is transmitted to the client 110 according to the pending interest table entries in the network elements 120 in the CCN 100.

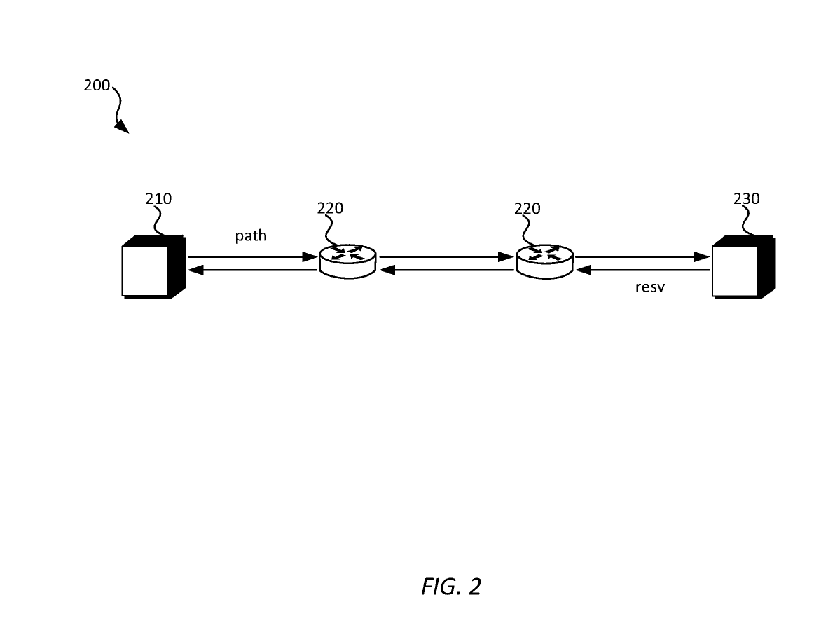

FIG. 2 is a schematic diagram of an embodiment of a network 200 utilizing a resource reservation protocol. Network 200 may be similar to CCN 100 in FIG. 1. Network 200 includes a client 210, one or more network elements 220, and a server 230. The client 210, network elements 220, and the server 230 may be similar to the client 110, network elements 120, and server 130 of FIG. 1. In network 200, the client 210 transmits a path message to the network element 220. The path message defines a desired data flow and indicates an address of a previous network element from which the path message was transmitted. The path message further includes elements that describe characteristics of data flow in network 200. When a path message is received from the network element 220, the path state is stored in the network element 220 before the path message is transmitted to a next network element 220 in the network 200.

The server 230 receives the path message from the network element 220 and replies with a resv message. The resv message traverses network 200 according to the path state stored in each network element 220 until it reaches the client 210. The resv message includes a flowspec characteristic that defines a QoS for the data flow. For example, the flowspec may indicate a minimum bandwidth that must be available in a network element 220 before that network element 220 transmits the data flow. In some embodiments, the resv message also includes a filterspec characteristic that indicates which data flow should be handled according to the flowspec. For example, a filterspec may indicate an Internet protocol (IP) address and/or one or more ports of that IP address for which the QoS defined by the flowspec should be maintained.

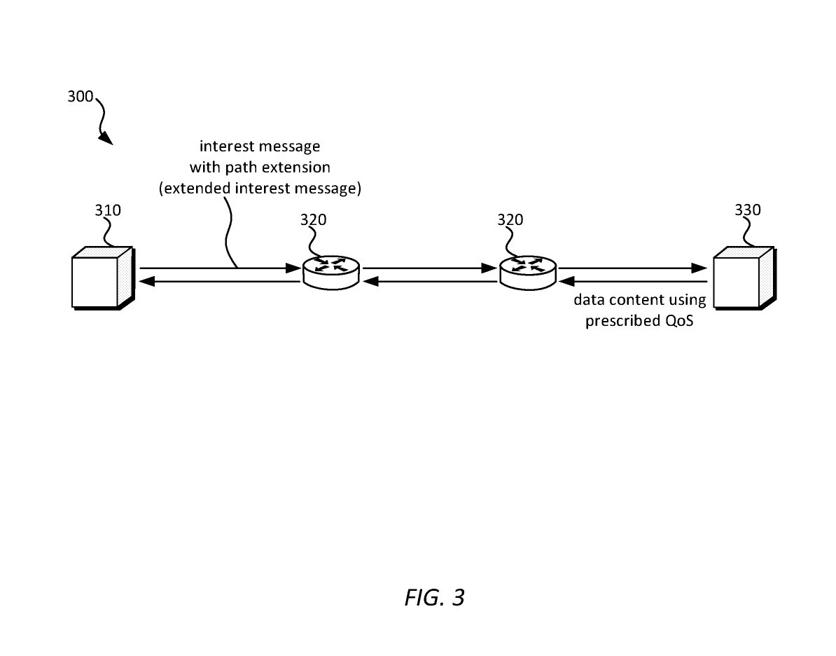

FIG. 3 is a schematic diagram of an embodiment of an information centric network 300 that provides a prescribed QoS. Network 300 may be similar to CCN 100 in FIG. 1 and network 200 in FIG. 2. Network 300 includes a client 310, one or more network elements 320, and a server 330. The client 310, network elements 320, and the server 330 may be similar to the clients 110, 210, network elements 120, 220, and server 130, 230 of FIGS. 1 and 2. In an embodiment of network 300, client 310 accesses desired data stored on a server 330 via one or more network elements 320. In some embodiments, the desired data may be accessed from a network element 320 in place of a server 330. The desired data comprises a content object that is accessible via a unique name and is provided to the client 310 according to a prescribed QoS value that indicates a minimum QoS to be maintained in network 300 for transmission of the desired data (e.g., a minimum QoS and/or bandwidth to be maintained to provide a prescribed Quality of Experience (QoE) in a video streaming application).

When client 310 wishes to access the desired data, an extended interest message is transmitted from client 310 to a network element 320. The extended interest message comprises a name of the desired data (e.g., a content object), a return address for the location in network 300 from which the extended interest message is being received, and a type-length-value (TLV) path extension that includes a path state that comprises a path identifier and/or prefix and a flowspec value for the data transfer. The flowspec value indicates a minimum QoS (e.g., a minimum necessary bandwidth) for transmitting the desired data through network 300 to client 310. As such, in an embodiment, the extended interest message comprises a content-based network resource reservation that provides a prescribed minimum quality of service level for a particular data (e.g., content object) being forwarded through network 300.

When a network element 320 receives an extended interest message in network 300, the network element 320 determines whether the desired data indicated by the extended interest message is stored in a cache on the network element 320. When the desired data is not stored in a cache on the network element 320, the network element 320 records a return route in the pending interest table that indicates a return route through network 300 to the return address from which the network element 320 received the extended interest message (e.g., the client 310 or another network element 320). Additionally, the network element 320 records a path state according to the TLV path extension of the extended interest message (e.g., the path identifier and/or prefix of the TLV path extension). The path state enables network elements 320 in network 300 to match the desired data to a specific path through the network 300 that is determined according to the extended interest message and is capable of supporting the prescribed QoS attributes. In an embodiment of network element 320 in which the extended interest message with the TLV path extension is not recognized and/or can not be understood, the network element 320 will process the extended interest message while omitting the TLV path extension. After recording the return route and path state, the network element 320 transmits the extended interest message to a next network element 320 in network 300. In an embodiment, the next network element 320 is the server 330 (e.g., a publisher or originator of the desired data). When the network element 320 determines that the desired data is stored in a cache on the network element 320, the desired data is transmitted to the last location in the network from which the extended interest message was received while maintaining any QoS attributes prescribed by the flowspec value in the extended interest message.

In some embodiments of network 300, a network element 320 may receive an extended interest message with prescribed QoS attributes that the network element 320 is unable to satisfy. When a network element 320 is unable to satisfy prescribed QoS attributes of a received extended interest message, in one embodiment, the network element 320 drops the extended interest message as unable to be satisfied and does not forward the extended interest message through the network 300. In another embodiment in which the network element 320 receives an extended interest message with prescribed QoS attributes that the network element 320 is unable to satisfy, the prescribed QoS attributes are reduced to an available level (e.g., by modifying the flowspec of the extended interest message) and the extended interest message continues through network as described above with the reduced level of prescribed QoS attributes. For example, if the prescribed QoS attributes request a QoS of 10 but the network element 320 is only capable of providing a QoS of 5, the prescribed QoS attributes are reduced to 5 and the extended interest message is forwarded through network 200 by the network element 320 as described above. In one embodiment, when the network element 320 reduces the prescribed QoS attributes to an available level (e.g., by modifying the flowspec of the extended interest message), the network element 320 inserts a flag into the extended interest message that indicates that the prescribed QoS attributes have been modified along the extended interest message's path through network 300. The insertion of the flag enables, for example, a client receiving the desired data to determine that the desired data is not being delivered according to the originally prescribed QoS attributes and to determine whether the reduced QoS level is sufficient to proceed.

When a server 330 receives the extended interest message, the server 330 locates the desired data and transmits it to the network element 320 from which the extended interest message was received. The desired data is transmitted to the network element 320 according to an address of the network element 320 that is included in the extended interest message, as well as the QoS attribute prescribed by the flowspec value in the extended interest message

When a network element 320 in network 300 receives the desired data, the QoS prescribed for the desired data and previously reserved in the network element 320 by the extended interest message is determined by comparing the name of the desired data to the path identifier and/or prefix that was previously recorded in the network element 320. The network element 320 then forwards the desired data with the prescribed QoS through network 300 according to the return route that was previously recorded in the pending interest table. In some embodiments, when a network element 320 receives the desired data and is unable to satisfy the prescribed QoS attributes, the network element 320 may negotiate the prescribed QoS attributes by modifying the desired data's path through network 300 and/or offering a reduced QoS according to a capacity that is available to the network element 320. For example, a flag may be added to a header of the desired data as it is transmitted through network 300. If a network element 320 receives the desired data with a prescribed QoS greater than can be provided, the network element 320 may provide the desired data with the maximum amount of bandwidth available less that the prescribed QoS and set the flag to indicate that the QoS has been modified. In another embodiment, when the network element 320 is capable of providing the prescribed QoS, the flag is set to indicate that the QoS has been satisfied.

It is understood that in some embodiments, a first network element 320 in network 300 may have a plurality of network elements 320 to which an extended interest message may be forwarded. In these embodiments, the first network element 320 may select a second network element 320 to which the extended interest message is forwarded according to available bandwidth between the first network element 320 and the second network element 320 and the name of the desired data as indicated by the extended interest message so as to provide a route through network 300 that will satisfy QoS attributes of the interest message. It is also understood that in some embodiments, the desired data may be stored in any combination of data caches and/or data servers (e.g., server 330) in network 300 and that data desired by a client (e.g., client 310) may be retrieved from either location. It is further understood that the client 310, network elements 320, and server 330 may each be referred to as a node in network 300.

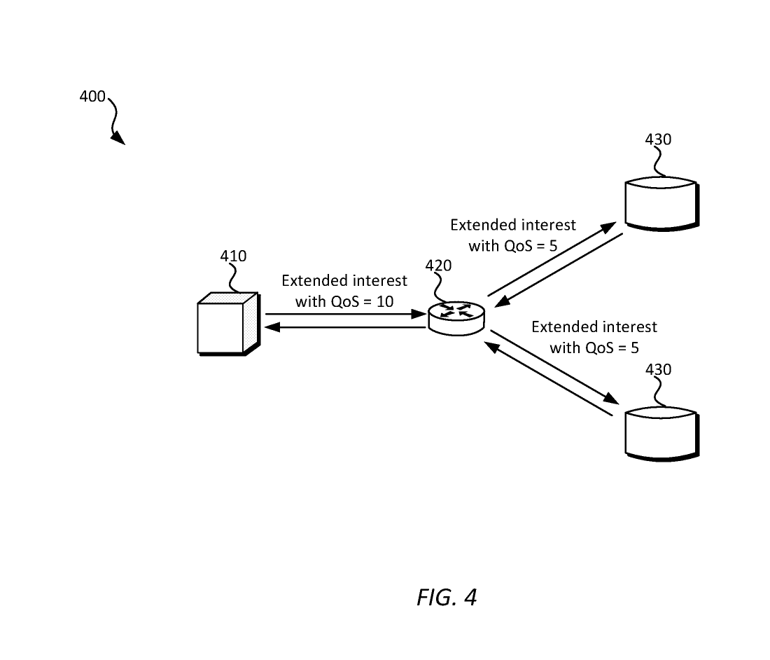

FIG. 4 is a schematic diagram of another embodiment of an information centric network 400 implemented in a manner that facilitates an aggregation of data paths. Network 400 may be similar to CCN 100 in FIG. 1, network 200 in FIG. 2, and network 300 in FIG. 3. Network 400 includes a client 410, a network element 420, and a server 430. The client 410, network element 420, and the server 430 may be similar to the clients 110, 210, 310, network elements 120, 220, 320, and server 130, 230, 330 of FIGS. 1-3. Although a single network element 420 is shown in FIG. 4, any number of network elements 420 may be included in network 400. The network element 420 may transmit an extended interest message to a plurality of servers (e.g., server 330, not shown in FIG. 4) and/or a plurality of data caches 430 to aggregate available QoS when a single server and/or cache 430 is unable to satisfy the prescribed QoS. For example, a network element 420 receives an extended interest message from a client 410 with a prescribed QoS of 10, but the network element 420 is unable to satisfy the QoS through forwarding to any one of the other network elements 420. The network element 420 may forward the extended interest message to a plurality of caches such that the aggregate divided QoS satisfies the prescribed QoS. For example, the network element 420 may forward the extended interest message with a divided QoS of 5 to two data caches 430 (e.g., by dividing the extended interest message into two consecutive halves). As such, the data path may be referred to as a directed tree rooted at the client 410 to deliver the prescribed QoS. When the network element 420 receives the two halves of the desired data from the caches 430, the two halves are reassembled into the complete desired data. In other embodiments, the extended interest message may be divided into any number of subsets before being forwarded by the network element 420, and the desired data may be received by the network element 420 in a corresponding number of subsets that are aggregated to form the desired data.

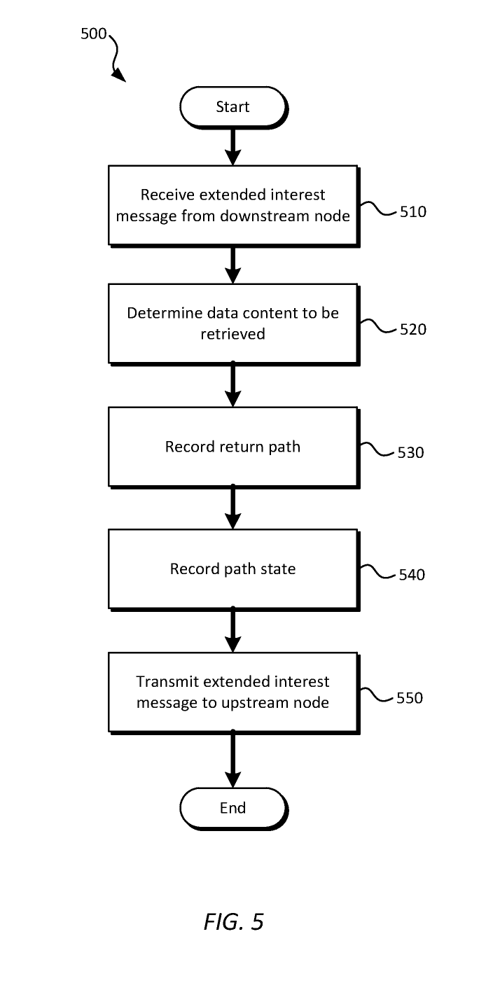

FIG. 5 is a flowchart of an embodiment of a method 500 for routing an extended interest message in an information centric network. In one embodiment, method 500 is executed in an information centric network (e.g., network 300, shown in FIG. 3 and/or network 400, shown in FIG. 4) when a network node transmits a request for data content. At step 510, a network element (e.g., network element 320, shown in FIG. 3) receives an extended interest message from a downstream node (e.g., a client 310, shown in FIG. 3) in the information centric network. At step 520, the network element determines what data content is to be retrieved according to the extended interest message. For example, in one embodiment the network element determines what data content is to be retrieved by reading a content name included in the extended interest message received from the downstream node. At step 530, information contained in the extended interest message is used to record a return path from the network element to the downstream node in the information centric network in a pending interest table of the network element. For example, in one embodiment the network element reads an IP address of the downstream node from the extended interest message received for the downstream node and saves the IP address in the pending interest table. At step 540, information contained in the extended interest message is used to record a path state in the network element. For example, in one embodiment the network element reads a path identifier that correlates the data content with a minimum QoS from the extended interest message and saves the path identifier in the network element as a path state. At step 550, the extended interest message is transmitted to an upstream node in the information centric network.

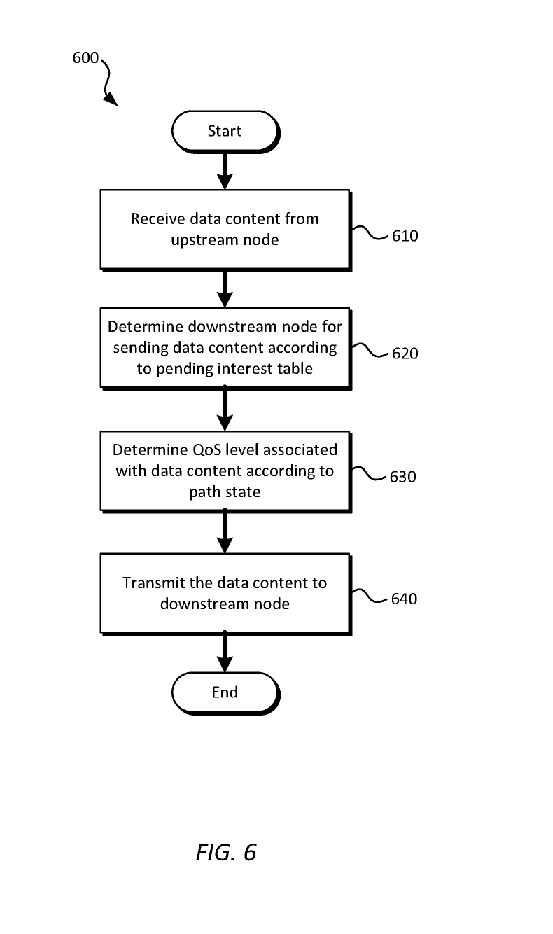

FIG. 6 is a flowchart of an embodiment of a method 600 for routing data content in an information centric network. In one embodiment, method 600 is executed in an information centric network (e.g., network 300, shown in FIG. 3 and/or network 400, shown in FIG. 4) when data content sought by a network node (e.g., through a method such as method 500, shown in FIG. 5) is being transmitted to the network node. At step 610, a network element (e.g., network element 320, shown in FIG. 3) receives data content from an upstream node (e.g., a server 330, shown in FIG. 3, another network element 320 that has cached the data content, or a data cache such as data cache 430, shown in FIG. 4) in the information centric network. At step 620, the network element examines an internal pending interest table to determine a downstream node to which the data content should be sent. For example, in one embodiment the network element reads the pending interest table of the network element to determines an IP address of the downstream node (e.g., an IP address saved at step 530 of method 500, shown in FIG. 5). At step 630, the network element examines an internal path state to determine what minimum QoS level should be associated with the data content. For example, in one embodiment the network element reads the path state saved in the network element at step 540, shown in FIG. 5, to correlate a minimum QoS level with the data content prior to transmitting the data content to the downstream node at step 640. At step 640, the data content is transmitted to the downstream node determined at step 620 with the minimum QoS level determined at step 630. In an embodiment, the data content received by the network element is received as a plurality of subsets, and the subsets are aggregated to form the data content.

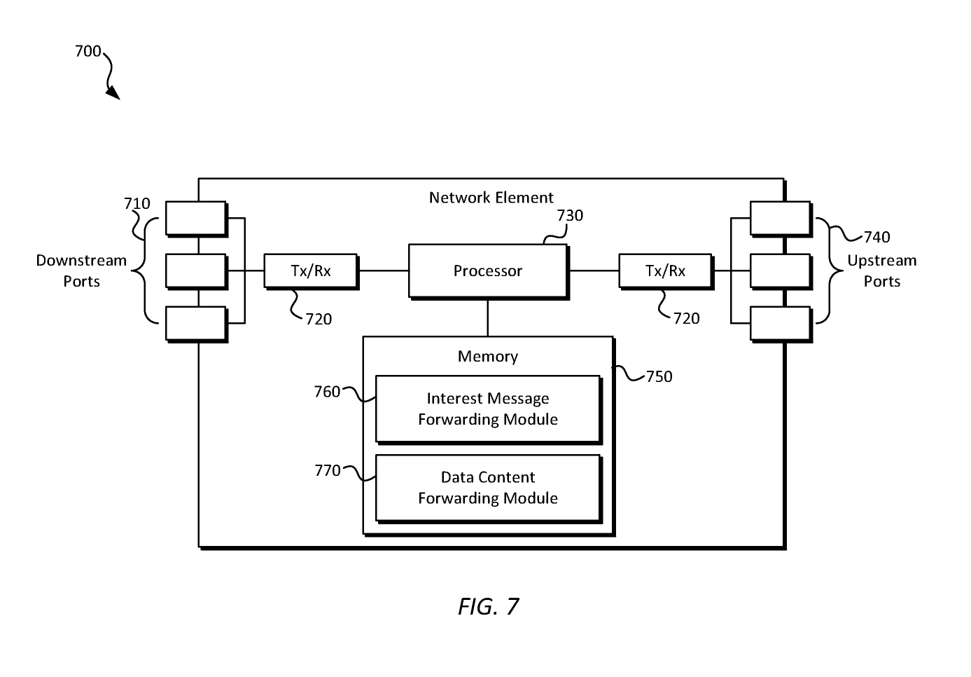

At least some of the features/methods described in this disclosure may be implemented in a network element (NE) 700. For instance, the features/methods of this disclosure may be implemented using hardware, firmware, and/or software installed to run on hardware. Network element 700 may be similar to network elements 110-410 as illustrated in FIGS. 1-4, respectively. The network element may be any device that stores and/or transports data through a network, e.g., a switch, router, bridge, server, client, cache, etc. FIG. 7 is a schematic diagram of an embodiment of a network element 700 that may be used to process extended interest messages and/or data content, as shown in FIG. 3 and FIG. 4. The network element 700 may be any device (e.g., an access point, an access point station, a router, a switch, a gateway, a bridge, a server, a client, a user-equipment, a mobile communications device, etc.) that transports data through a network, system, and/or domain. Moreover, the terms network “element,” network “node,” network “component,” network “module,” and/or similar terms may be interchangeably used to generally describe a network device and do not have a particular or special meaning unless otherwise specifically stated and/or claimed within the disclosure. Additionally, a data cache may be implemented in the network element 700 to store data that is transmitted by the network element 700.

The network element 700 may comprise one or more downstream ports 710 coupled to a transceiver (Tx/Rx) 720, which may be transmitters, receivers, or combinations thereof. The Tx/Rx 720 may transmit and/or receive frames from other network nodes via the downstream ports 710. Similarly, the network element 700 may comprise another Tx/Rx 720 coupled to a plurality of upstream ports 740, wherein the Tx/Rx 720 may transmit and/or receive frames from other nodes via the upstream ports 740. The downstream ports 710 and/or the upstream ports 740 may include electrical and/or optical transmitting and/or receiving components. In another embodiment, the network element 700 may comprise one or more antennas coupled to the Tx/Rx 720. The Tx/Rx 720 may transmit and/or receive data (e.g., packets) from other network elements wirelessly via one or more antennas.

A processor 730 may be coupled to the Tx/Rx 720 and may be configured to process the frames and/or determine to which nodes to send (e.g., transmit) the packets. In an embodiment, the processor 730 may comprise one or more multi-core processors and/or memory modules 750, which may function as data stores, buffers, etc. The processor 730 may be implemented as a general processor or may be part of one or more application specific integrated circuits (ASICs), field-programmable gate arrays (FPGAs), and/or digital signal processors (DSPs). Although illustrated as a single processor, the processor 730 is not so limited and may comprise multiple processors. The processor 730 may be configured to communicate and/or process multi-destination frames.

FIG. 7 also illustrates that a memory module 750 may be coupled to the processor 730 and may be a non-transitory medium configured to store various types of data. Memory module 750 may comprise memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory module 750 may be used to house the instructions for carrying out the various embodiments described herein. In one embodiment, memory module 750 may comprise an interest message forwarding module 760 which may be implemented on processor 730 and configured to forward extended interest messages having a prescribed QoS attribute through a network. In another embodiment, memory module 750 may comprise a data content forwarding module 770 which may be implemented on processor 730 and configured to transmit data content through the network according to content-based resource reservations established in the network according to the extended interest message. Method 500 in FIG. 5 and method 600 in FIG. 6 may be implemented using one or more of the processor 730, the memory module 750, and the interest message forwarding module 760.

It is understood that by programming and/or loading executable instructions onto the network element 700, at least one of the processor 730 and/or the memory 750 are changed, transforming the network element 700 in part into a particular machine or apparatus, for example, a multi-core forwarding architecture having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable and will be produced in large volume may be preferred to be implemented in hardware (e.g., in an ASIC) because for large production runs the hardware implementation may be less expensive than software implementations. Often a design may be developed and tested in a software form and then later transformed, by well-known design rules known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Any processing of the present disclosure may be implemented by causing a processor (e.g., a general purpose multi-core processor) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM, flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A network element, comprising:
a memory comprising a pending interest table;
a receiver operably coupled to the memory and configured to receive an extended interest message in an information centric network;
a processor operably coupled to the receiver and the memory and configured to:
determine a desired content according to the extended interest message;
determine a prescribed quality of service (QoS) level requested for delivering the desired content to a client;
record a path state in the memory;
record a return route in the pending interest table of the memory, wherein the return route comprises a route through the information centric network to a return address of a previous location in the information centric network; and
determine a next location in the information centric network to which the extended interest message is to be sent; and
a transmitter operably coupled to the processor and configured to transmit the extended interest message to the next location in the information centric network.

2. The network element of claim 1, wherein the extended interest message comprises a desired content name, an address of a location in the information centric network from which the extended interest message was received, a flowspec value that indicates the prescribed QoS, and a type-length-value (TLV) path extension.

3. The network element of claim 2, wherein the TLV path extension comprises the path state that comprises an identifier for associating the desired content with the prescribed QoS.

4. The network element of claim 3, wherein the processor is further configured to divide the extended interest message into a plurality of extended interest message pieces each having a divided QoS less than the prescribed QoS of the extended interest message, and wherein the transmitter is further configured to transmit the plurality of extended interest message pieces to a plurality of next locations in the information centric network such that an aggregate of the divided QoS equals the prescribed QoS of the extended interest message.

5. The network element of claim 4, wherein the receiver is further configured to receive a plurality of pieces of the desired content corresponding to the plurality of extended interest message pieces, wherein the processor is further configured to aggregate the plurality of pieces of the desired content to create the desired content, and wherein the transmitter is further configured to transmit the desired content according to the return route in the pending interest table of the memory.

6. The network element of claim 3, wherein the receiver is further configured to receive the desired content, and wherein the transmitter is configured to transmit the desired content according to the return route in the pending interest table of the memory.

7. The network element of claim 1, wherein the network element further comprises a data cache, and wherein the desired content is stored in the data cache.

8. A method implemented in a network element for routing an extended interest message in an information centric network, comprising:
receiving, by the network element, the extended interest message from a downstream node in the information centric network;
determining, according to the extended interest message, data content to be retrieved;
recording a return path from the network element to the downstream node in the information centric network in a pending interest table;
recording a path state in the network element; and
transmitting the extended interest message to an upstream node in the information centric network.

9. The method of claim 8, wherein the extended interest message comprises:
a name of the data content to be retrieved;
an address of an immediately preceding node in the information centric network; and
a minimum quality of service (QoS) level.

10. The method of claim 9, wherein the minimum quality of service level comprises a minimum quantity of bandwidth for use in transmitting the data content to be retrieved downstream in the information centric network.

11. The method of claim 9, wherein the path state comprises an indicator that corresponds the data content to the minimum QoS level.

12. The method of claim 9, wherein the minimum QoS level is satisfied by transmitting the extended interest message with a reduced minimum QoS level to a plurality of upstream nodes in the information centric network, and wherein an aggregate of the plurality of upstream nodes providing the reduced minimum QoS level equals the minimum quality of service.

13. The method of claim 9, wherein determining, according to the extended interest message, data content to be retrieved comprises:
determining a name of the data content to be retrieved;
determining whether the data content is cached on the network element; and
transmitting the data content to the downstream node when the data content is cached on the network element.

14. The method of claim 9, wherein the extended interest message comprises a content-based network resource reservation in the information centric network.

15. The method of claim 9, wherein the network element is unable to provide the minimum QoS level, wherein the network element reduces the minimum QoS level to an available QoS level prior to transmitting the extended interest message, and wherein the network element inserts an indicator into the extended interest message to indicate that the minimum QoS level has been reduced to the available QoS level.

16. A method implemented in a network element for routing data content in an information centric network, comprising:
receiving, by the network element, the data content from an upstream node in the information centric network;
determining a downstream location in the information centric network for sending the data content according to an entry in a pending interest table of the network element;
associating the data content with a minimum quality of service (QoS) level according to a path state of the network element; and
transmitting the data content to the downstream location in the information centric network with the minimum quality of service level.

17. The method of claim 15, wherein the data content is received by the network element as a plurality of subsets, and wherein the subsets are aggregated to form the data content.

18. The method of claim 15, wherein the network element sets a flag on a header of the data content to indicate that the minimum QoS level is satisfied.

19. The method of claim 15, wherein the network element determines an alternate path for the data content through the information centric network when the minimum QoS level is not available, and wherein the network element sets a flag on a header of the data content to indicate that the minimum QoS level has not been satisfied.

20. The method of claim 15, paths utilized by the network element for forwarding the data content downstream in the information centric network comprise content-based reserved data paths.
